(19) United States
(12) Patent Application Publication
(10) Pub. No.: US 2009/0239608 A1
(43) Pub. Date: Sep. 24, 2009

(54) Gaming Machine Executing A Bonus Game And Control Method Thereof

(75) Inventor: Nakayasu TSUKAHARA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/172,679

(22) Filed: Jul. 14, 2008

Related U.S. Application Data
(60) Provisional application No. 61/038,516, filed on Mar. 21, 2008.

(51) Int. Cl. A63F 9/24; A63F 13/00

(52) U.S. Cl. 463/20

(57) ABSTRACT

According to the gaming machine of the present invention, a total payout amount in a bonus game is determined by determining a rearrangement pattern showing symbols to be rearranged in each of unit games constituting the bonus game or a combination of the symbols, and then calculating the payout amount in each of the unit games based on the rearrangement pattern and summing the payout amount in all of the unit games. Subsequently, an effect pattern data corresponding to the total payout amount is selected from a plurality of kinds of effect pattern data stored in a memory. In the bonus game, the symbols are rearranged based on the determined rearrangement pattern data and then an effect based on the selected effect pattern data is executed.

### CROSS-REFERENCE TO RELATED APPLICATIONS

This application claims benefit of priority based on U.S. Provisional Patent Application No. 61/038,516 filed on Mar. 21, 2008. The contents of this application are incorporated herein by reference in their entirety.

### BACKGROUND OF THE INVENTION

1. Field of the Invention

The present invention relates to a gaming machine executing a bonus game and a control method thereof.

2. Discussion of the Background

Conventionally, there exists a slot machine that executes a free game as a bonus game when a prescribed condition (e.g. specific symbols are rearranged in a slot machine game) is established during a game. The free game is a game that can be played without consuming game media. For example, Australian Patent Publication No. 1972901 discloses a slot machine on which a free game is played as a side game when a prescribed condition (i.e. symbols are arranged in a specific pattern) is established in a basic game.

In the slot machine game as described above, the free game may often be the biggest chance for a player to obtain a large payout, and for a manufacturer of the gaming machine, in the case where a large amount of payout are going to be offered, it is ideal to make the player aware of the payout by the effect of a plurality of free games so as to raise an expectation of the player.

However, since a conventional slot machine decides a payout to be offered in a free game at random every time the free game is played, a total payout amount over a plurality of free games is greatly varied. Hence, even if effects suggesting a large amount of payout are performed over the plurality of free games, there is a possibility that an amount of the actually offered total payout becomes significantly smaller than an amount of an expected payout, and thus contents of the effects turn out to be false. This may cause a problem that the player has distrust in the game, the gaming machine, and further a manufacturer of the gaming machine.

The present invention was made in view of the foregoing problem, and an object of the present invention is to provide a gaming machine capable of performing an appropriate effect reflecting a total payout amount in a bonus game, and a method for controlling the gaming machine.

The contents of Australian Patent Publication No. 1972901 are incorporated herein by reference in their entirety.

### SUMMARY OF THE INVENTION

A first embodiment of the present invention provides a gaming machine having the following configuration.

Namely, the gaming machine includes a display capable of arranging and displaying symbols. Further, the gaming machine includes a memory that stores a plurality of kinds of effect pattern data for use in executing an effect, each of the effect pattern data being corresponded to a total payout amount in a bonus game in which a unit game executing rearrangement and display of the symbols to the display is played over a plurality of times. Moreover, the gaming machine includes a controller programmed to execute processing of (a) executing a normal game in which the symbols are rearranged and displayed to the display,

(b) deciding whether or not to execute the bonus game,

(c) determining a rearrangement pattern showing the symbols to be rearranged in each of the unit games constituting the bonus game, or a combination of the symbols,

(d) determining a total payout amount in the bonus game by calculating a payout amount in each of the unit games based on the rearrangement pattern determined in the processing (c) and summing the payout amount in all of the unit games,

(e) selecting one effect pattern data out of effect pattern data corresponded to the total payout amount determined in the processing (d), among the plurality of kinds of the effect pattern data stored in the memory, and

(f) executing rearrangement of the symbols displayed to the display based on the rearrangement pattern determined in the processing (c), while executing an effect based on the effect pattern data selected in the processing (e) in each of the unit games constituting the bonus game when it is decided in the processing (b) that the bonus game will be executed.

According to the above gaming machine, a total payout amount in a bonus game is determined by determining a rearrangement pattern showing the symbols to be rearranged in each of the unit games constituting the bonus game or a combination of the symbols, and then calculating and summing the payout amount in each of the unit games based on the rearrangement pattern. Subsequently, an effect pattern data corresponding to the total payout amount is selected from a plurality of kinds of effect pattern data stored in a memory (e.g. ROM). Further, in the bonus game, the symbols are rearranged based on the determined rearrangement pattern data and then an effect based on the selected effect pattern data is executed.

Namely, on the above gaming machine, the bonus game is played after a total payout amount in the bonus game has been determined, and further, an effect is executed based on effect pattern data corresponding to the determined total payout amount in the bonus game. Therefore, when the total payout amount is determined to be a relatively large value, an effect suggesting a large amount of payout can be executed, whereas when the total payout amount is determined to be a relatively small value, an effect that excessively provokes an expectation of the player can be avoided. Accordingly, since an effect in accordance with the total payout amount to be offered can be executed, it becomes possible to avoid a condition where a payout expected from the effect is significantly different from an actual total payout amount, and therefore it becomes possible to prevent the player from being mistrustful of the game.

Moreover, by determining the total payout amount prior to execution of the bonus game, an effect in accordance with the total payout amount can be executed as a series of effects over a plurality of unit games, it is possible to gradually raise the expectation of the player for results of the bonus game as each of the unit games is played. It is thus possible to further increase amusement of the bonus game.

Furthermore, since the rearrangement pattern of the symbols in the bonus game is determined by determining symbols to be rearranged in each of the unit games constituting the bonus game or a combination of the symbols by means of random numbers or the like before the bonus game is executed, it is not necessary to previously store the rearrangement pattern data, and thus it becomes possible to reduce the capacity of the memory to be used.

Preferably, the above-mentioned gaming machine further has the following configuration.

Namely, the processing (c) is processing of determining the symbols to be rearranged in each of the unit games constituting the bonus game, or a combination of the symbols when it is decided in the processing (b) that the bonus game will be executed.

According to the above gaming machine, since the rearrangement pattern of the symbols in the bonus game is not previously determined but determined when the bonus game is determined to be executed, it is possible to make the bonus game more varied, e.g. a process until decision of execution of the bonus game is reflected on the rearrangement pattern of the symbols.

A second embodiment of the present invention provides a gaming machine having a following configuration.

Namely, the gaming machine includes a display capable of arranging and displaying symbols. Further, the gaming machine includes a memory that stores a plurality of kinds of effect image data for use in executing an effect, each of the effect image data being corresponded to a total payout amount in a bonus game in which a unit game executing rearrangement and display of the symbols to the display is played over a plurality of times. Moreover, the gaming machine includes a controller programmed to execute processing of (a) executing a normal game in which the symbols are rearranged and displayed to the display,

(b) deciding whether or not to execute the bonus game,

(c) determining a rearrangement pattern showing the symbols to be rearranged in each of the unit games constituting the bonus game, or a combination of the symbols,

(d) determining a total payout amount in the bonus game by calculating a payout amount in each of the unit games based on the rearrangement pattern determined in the processing (c) and summing the payout amount in all of the unit games,

(e) selecting one effect image data out of effect image data corresponded to the total payout amount determined in the processing (d), among the plurality of kinds of the effect image data stored in the memory, and

(f) executing rearrangement of the symbols displayed to the display based on the rearrangement pattern determined in the processing (c), while displaying to the display an effect image based on the effect image data selected in the processing (e) in each of the unit games constituting the bonus game when it is decided in the processing (b) that the bonus game will be executed

According to the above gaming machine, a total payout amount in a bonus game is determined by determining a rearrangement pattern showing the symbols to be rearranged in each of the unit games constituting the bonus game or a combination of the symbols, and then calculating and summing the payout amount in each of the unit games based on the rearrangement pattern. Subsequently, an effect image data corresponding to the total payout amount is selected from a plurality of kinds of effect image data stored in a memory (e.g. ROM). In the bonus game, the symbols are rearranged based on the determined rearrangement pattern data and then an effect of displaying an effect image based on the selected effect image data is executed.

Namely, on the above gaming machine, the bonus game is played after a total payout amount in the bonus game has been determined, and further, an effect is executed based on effect pattern data corresponding to the determined total payout amount. Therefore, when the total payout amount is determined to be a relatively large value, an effect suggesting a large amount of payout can be executed, whereas when the total payout amount is determined to be a relatively small value, an effect that excessively provokes an expectation of the player can be avoided. Accordingly, since an effect depending on the total payout amount to be offered can be executed, a condition where a payout expected from an effect is significantly different from an actual total payout amount can be prevented so that the player can be prevented from becoming mistrustful.

Moreover, by determining the total payout amount prior to execution of the bonus game, an effect in accordance with the total payout amount can be executed as a series of effects over a plurality of unit games, it is possible to gradually raise the expectation of the player for results of the bonus game as each of the unit games is played. It is thus possible to further increase amusement of the bonus game.

Further, since an effect by means of an image is executed in the bonus game, it becomes easier for the player to visually judge whether or not a large amount of payout will be offered.

Furthermore, since the rearrangement pattern of the symbols in the bonus game is determined by determining symbols to be rearranged in each of the unit games constituting the bonus game or a combination of the symbols by means of random numbers or the like before the bonus game is executed, it is not necessary to previously store the rearrangement pattern data, and thus it is possible to reduce the capacity of the memory to be used.

Preferably, the above-mentioned gaming machine further has the following configuration.

Namely, the processing (c) is processing of determining the symbols to be rearranged in each of the unit games constituting the bonus game, or a combination of the symbols when it is decided in the processing (b) that the bonus game will be executed.

According to the above gaming machine, since the rearrangement pattern of the symbols in the bonus game is not previously determined but determined when the bonus game is determined to be executed, it is possible to make the bonus game more various such as, for example, a process until decision of execution of the bonus game may be reflected on the rearrangement pattern of the symbols.

A third embodiment of the present invention provides a method for controlling a gaming machine having the following configuration.

Namely, the above method for controlling the gaming machine includes the steps of (a) executing a normal game in which symbols are rearranged and displayed to the display,

(b) deciding whether or not to execute a bonus game in which a unit game executing rearrangement and display of the symbols to the display is played over a plurality of times,

(c) determining a rearrangement pattern showing the symbols to be rearranged in each of the unit games constituting the bonus game, or a combination of the symbols,

(d) determining a total payout amount in the bonus game by calculating a payout amount in each of the unit games based on the rearrangement pattern determined in the step (c) and summing the payout amount in all of the unit games,

(e) selecting one effect pattern data out of effect pattern data corresponded to the total payout amount determined in the step (d) among the plurality of kinds of the effect pattern data for use in executing an effect stored in the memory, each of the effect pattern data being corresponded to the total payout amount in the bonus game, and

(f) executing rearrangement of the symbols displayed to the display based on the rearrangement pattern determined in the step (c), while executing an effect based on the effect pattern data selected in the step (e), in each of the unit games constituting the bonus game when it is decided in the step (b) that the bonus game will be executed.

According to the above method for controlling a gaming machine, a total payout amount in a bonus game is determined by determining a rearrangement pattern showing the symbols to be rearranged in each of the unit games constituting the bonus game or a combination of the symbols, and then calculating and summing the payout amount in each of the unit games based on the rearrangement pattern. Subsequently, an effect pattern data corresponding to the total payout amount is selected from a plurality of kinds of effect pattern data stored in a memory (e.g. ROM). Further, in the bonus game, the symbols are rearranged based on the determined rearrangement pattern data and then an effect based on the selected effect pattern data is executed.

Namely, the bonus game is played after a total payout amount in the bonus game has been determined, and further, an effect is executed based on effect pattern data corresponding to the determined total payout amount. Therefore, when the total payout amount is determined to be a relatively large value, an effect suggesting a large amount of payout can be executed, whereas when the total payout amount is determined to be a relatively small value, an effect that excessively provokes an expectation of the player can be avoided. Accordingly, since an appropriate effect in accordance with the total payout amount to be offered can be executed, it is possible to avoid a condition where a payout expected from the effect is significantly different from an actual total payout amount. Therefore it becomes possible to prevent the player from being mistrustful of the game.

Moreover, by determining the total payout amount prior to execution of the bonus game, an effect in accordance with the total payout amount can be executed as a series of effects over a plurality of unit games, it is possible to gradually raise the expectation of the player for results of the bonus game as each of the unit games is played. It is thus possible to further increase amusement of the bonus game.

Furthermore, since the rearrangement pattern of the symbols in the bonus game is determined by determining symbols to be rearranged in each of the unit games constituting the bonus game or a combination of the symbols by means of random numbers or the like before the bonus game is executed, it is not necessary to previously store the rearrangement pattern data, and thus it becomes possible to reduce the capacity of the memory to be used.

Preferably, the above method for controlling a gaming machine further has the following configuration.

Namely, the step (c) is step of determining the symbols to be rearranged in each of the unit games constituting the bonus game, or a combination of the symbols when it is decided in the step (b) that the bonus game will be executed.

According to the above method for controlling a gaming machine, since the rearrangement pattern of the symbols in the bonus game is not previously determined but determined when the bonus game is determined to be executed, it is possible to make the bonus game more varied, e.g. a process until decision of execution of the bonus game is reflected on the rearrangement pattern of the symbols.

### BRIEF DESCRIPTION OF THE DRAWINGS

FIG. 1 is a flowchart showing a subroutine of game execution processing.

FIG. 2 is a perspective view showing appearance of a slot machine according to one embodiment of the present invention.

FIG. 3 is a pattern diagram showing columns of symbols to be displayed on respective display blocks.

FIG. 4 is a table showing the corresponding relations among a total payout amount, number of free games and effect pattern data in a bonus game.

FIG. 5 is a view showing an example of images displayed to a lower-side image display panel.

FIG. 6 is a view showing an example of images displayed to the lower-side image display panel.

FIG. 7 is a block diagram showing an internal configuration of a slot machine shown in FIG. 2.

FIG. 8 is a flowchart showing a procedure for activation processing performed by a motherboard and a gaming board.

FIG. 9 is a flowchart showing a procedure for peripheral device initialization processing.

FIG. 10 is a flowchart showing a subroutine of activation processing executed by a central controller.

FIG. 11 is a flowchart showing a subroutine of symbol determination processing.

FIG. 12 is a view showing the relation among a plurality of kinds of prizes, establishment probability of each prize, and number of payouts.

FIG. 13 is a flowchart showing a subroutine of bonus game processing.

### DESCRIPTION OF THE EMBODIMENTS

An embodiment of the present invention is described based on drawings.

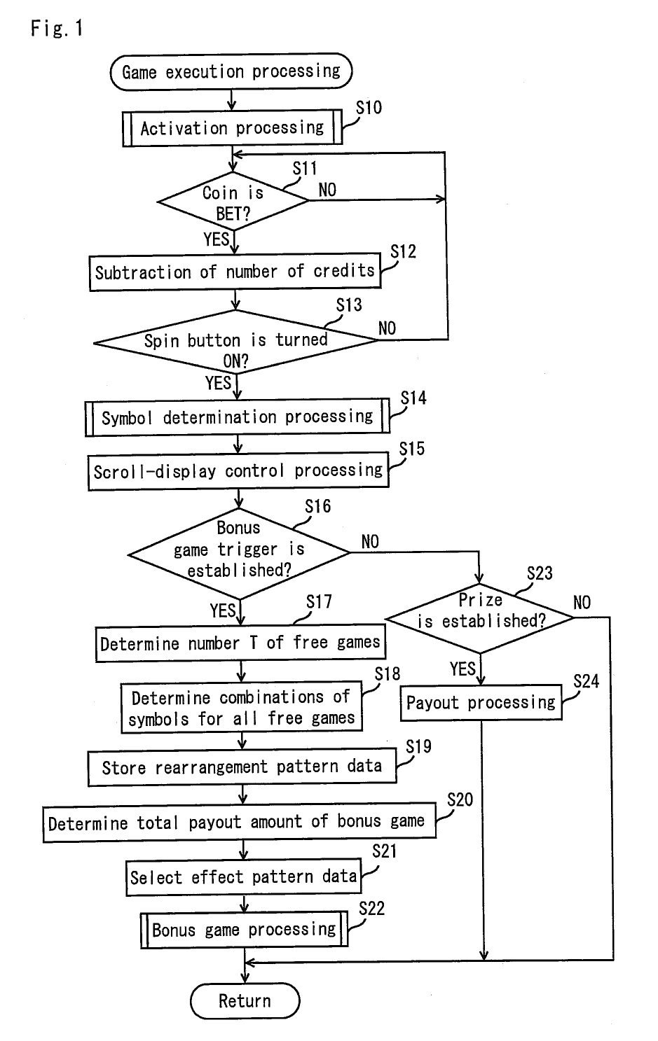

FIG. 1 is a flowchart showing a subroutine of game execution processing.

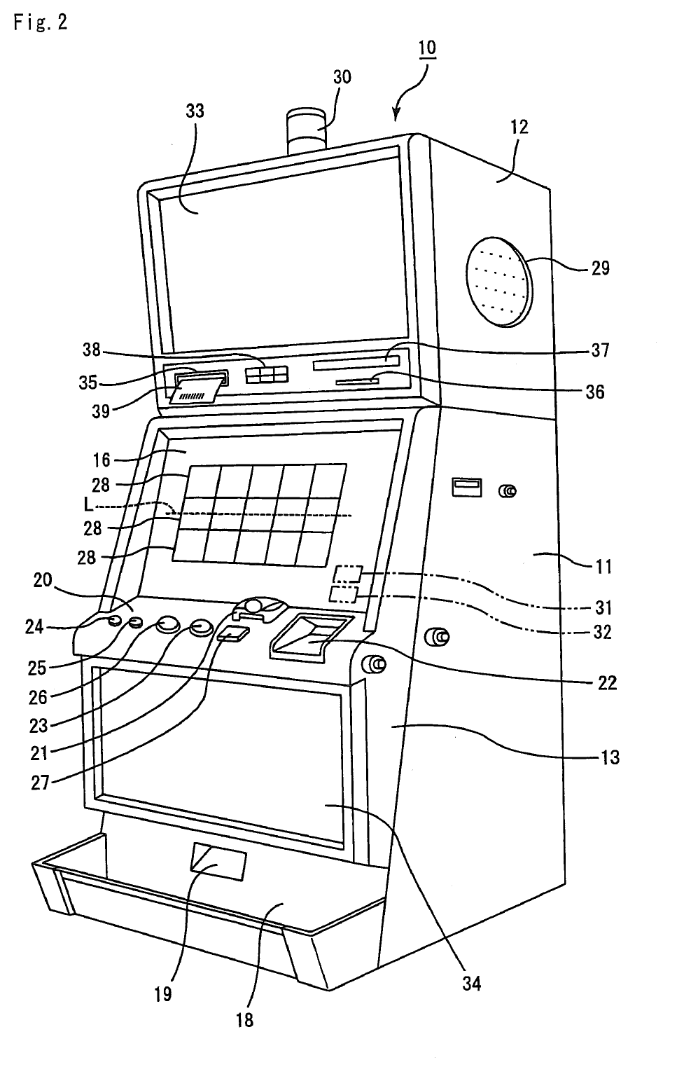

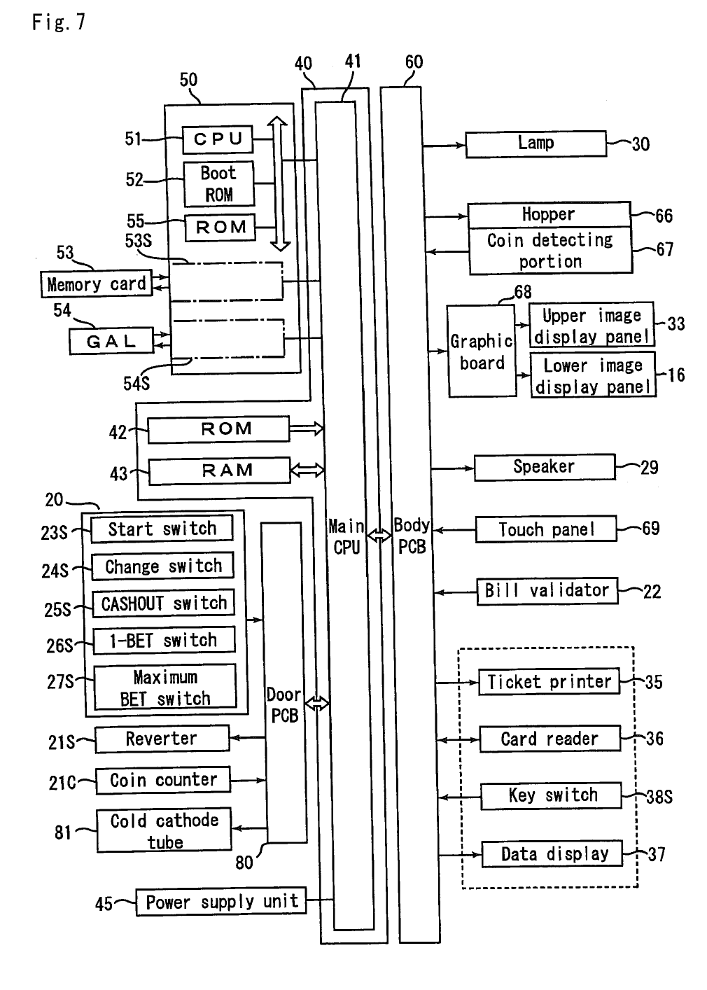

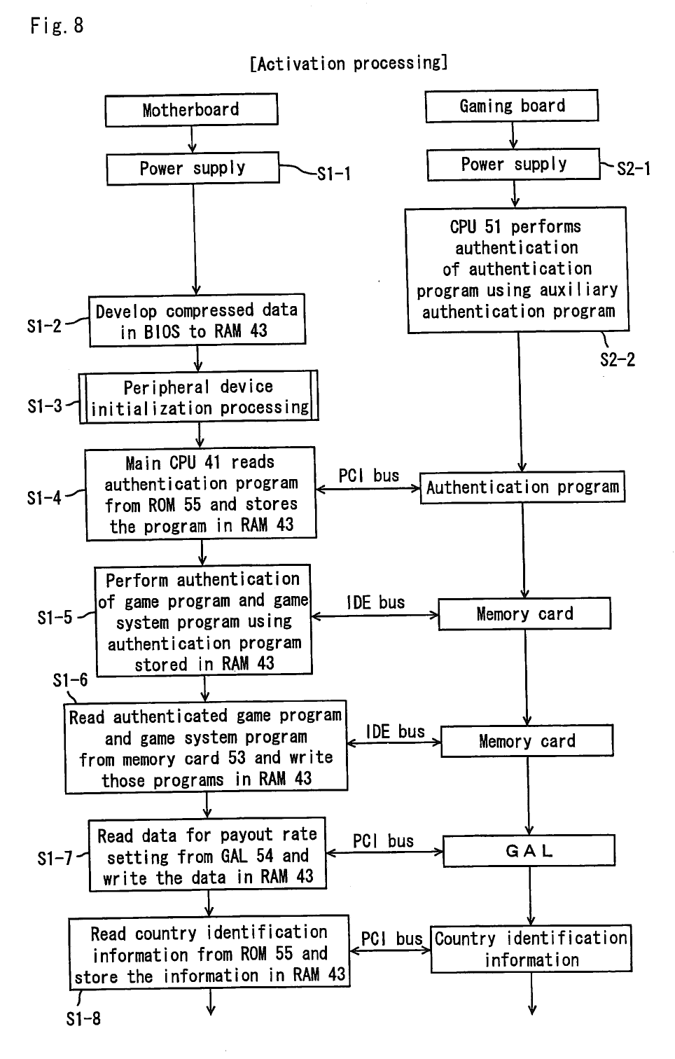

In the game execution processing, first, a main CPU 41 (see FIG. 7) in a slot machine 10 (see FIG. 2) according to the present embodiment performs activation processing (step S10) by a motherboard 40 and a gaming board 50 (see FIG. 7). The activation processing is detailed later using FIGS. 8 to 10.

Next, the main CPU 41 determines whether or not coins have been betted (step S11). In this processing, the main CPU 41 determines whether or not an input signal outputted from a 1-BET switch 26S (see FIG. 7) has been received when a 1-BET button 26 (see FIG. 2) is operated, or whether or not an input signal outputted from a maximum BET switch 27S (see FIG. 7) has been received when a maximum BET button 27 (see FIG. 2) is operated. When determining that coins have not been betted, the main CPU 41 returns the processing to step S11.

On the other hand, when determining in step S11 that coins have been betted, the main CPU 41 performs processing of subtraction from the number of credits stored in the RAM 43 (see FIG. 7) in accordance with the number of betted coins (step S12). It is to be noted that, when the number of betted coins is larger than the number of credits stored in the RAM 43, the main CPU 41 returns the processing to step S11 without performing the processing of subtraction from the number of credits stored in the RAM 43. Moreover, when the number of betted coins exceeds an upper limit value bettable in one game (50 in the present embodiment), the main CPU 41 advances the processing to step S13 without performing the processing of subtraction from the number of credits stored in the RAM 43.

Next, in step S13, the main CPU 41 determines whether or not a spin button 23 (see FIG. 2) has been turned ON. In this processing, the main CPU 41 determines whether or not the main CPU 41 has received an input signal that is outputted from a start button 23S (see FIG. 7) when the spin button 23 is pressed down.

When determining that the spin button 23 has not been turned ON, the main CPU 41 returns the processing to step S11. It is to be noted that, when the spin button 23 is not turned ON (e.g. when a command indicating end of the game is inputted without turning-on of the spin button 23), the main CPU 41 cancels the subtraction result in step S12.

On the other hand, when determining in step S13 that the spin button 23 has been turned ON, the main CPU 41 shifts the processing to step S14.

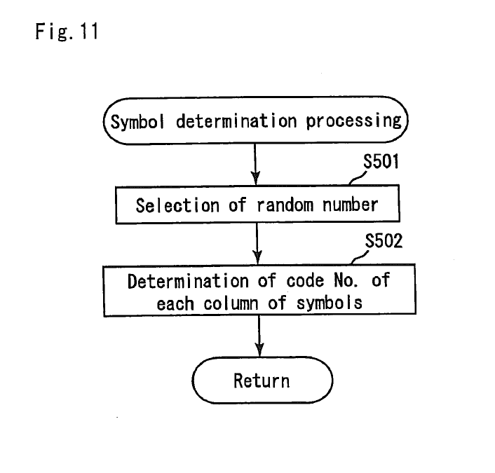

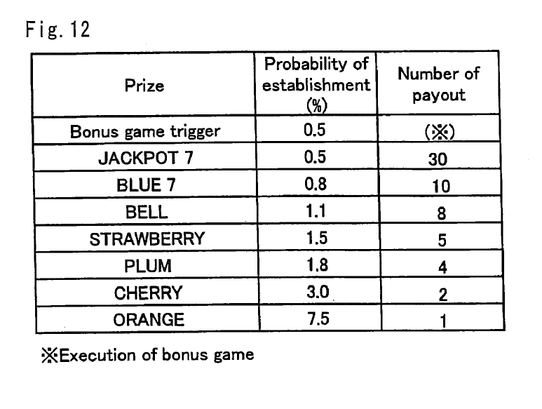

Next, the main CPU 41 performs symbol determination processing (step S14). In this symbol determination processing, the main CPU 41 executes a symbol determination program stored in the RAM 43, to decide a code No. at stopping of symbols. Thereby, a combination of symbols to be rearranged is determined. This processing is detailed later using FIGS. 11 and 12. It should be noted that the case was described in the present embodiment where a combination of symbols to be rearranged are determined, thereby to decide one prize out of a plurality of kinds of prizes. However, in the present invention, it may be possible for example that one prize selected out of a plurality of prizes may be decided first, followed by determination of a combination of symbols to be rearranged.

Next, the main CPU 41 performs scroll display control processing (step S15). This processing is processing of stopping scroll display of each display block 28 (see FIG. 2) such that a combination of symbols corresponding to the prize decided in step S14 is rearranged on a winning line L (see FIG. 2) after scroll display of symbols has been started.

Next, the main CPU 41 determines whether or not a bonus game trigger has been established, namely whether or not five “APPLE” symbols are rearranged on the winning line L. (step S16).

When determining that the bonus game trigger has been established, the main CPU 41 determines the number T of free games in the bonus game by means of random numbers (step S17). The range of the value T is from 2 to 25. The free game is a game in which the player can play the game without newly inserting game media. The free game according to the present embodiment corresponds to the unit game in the present invention.

Next, the main CPU determines a combination of symbols to be rearranged (rearrangement pattern) by means of random numbers (step S18) for every turn of the free games for the number of times determined in the step 17.

Subsequently, the main CPU 41 makes the RAM 43 store the rearrangement pattern determined in step 18 as rearrangement pattern data (step S19).

Next, the main CPU 41 determines a total payout amount in the bonus game, namely T times of free games, based on the rearrangement pattern determined in step S18 (step S20). Specifically, the main CPU 41 determines a payout amount in each time of free game based on the rearrangement pattern data determined in step S18, and then sums those payout amount to determine a total payout amount in the bonus game. For example, when the number of times of the free game is three, and rearrangement patterns corresponding to 10 coins, 5 coins, and 2 coins are determined in the first free game, the second free game, and the third free game, respectively, the total payout amount in the relevant bonus game is determined to be 17 coins.

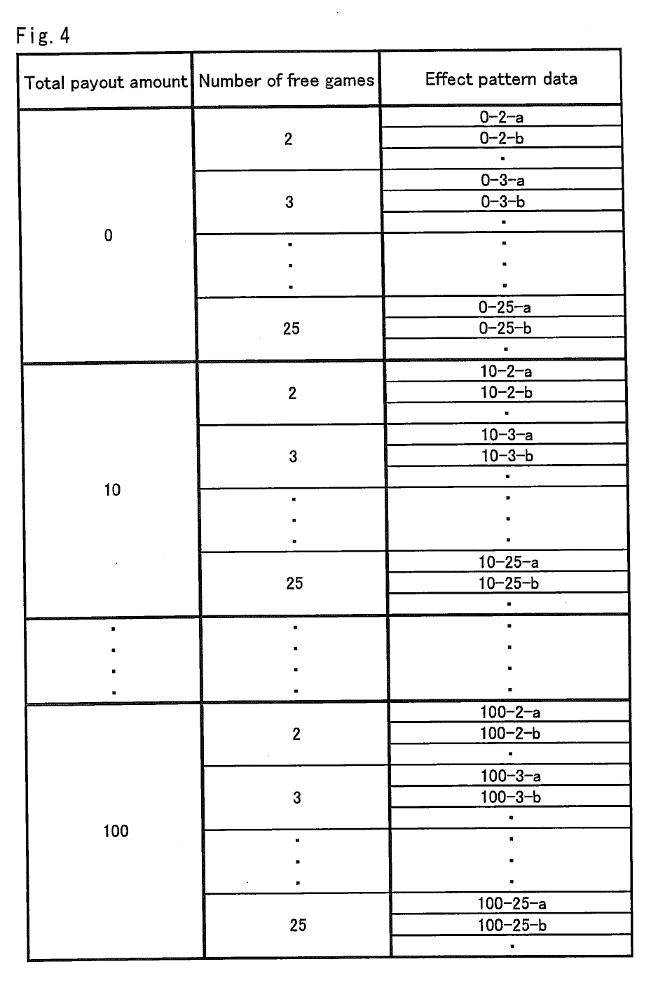

Next, with reference to a data table stored in the RAM 43, the main CPU 41 selects effect pattern data in the bonus game based on the number T of free games and the total payout amount in the bonus game (step S21). The effect pattern data is data showing a pattern of an effect using an image or sound during the bonus game, and a plurality of kinds of the effect pattern data corresponded to the total payout amount or the number of free games in the bonus game are stored in the RAM 43. The corresponding relation among the total payout amount, the number of free games in the bonus game, and the effect pattern data is detailed later using FIG. 4.

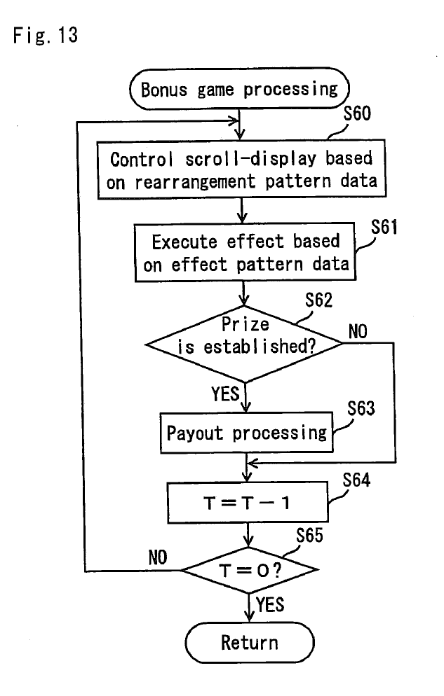

Next, the main CPU 41 reads a program for performing a bonus game from the RAM 43, to execute bonus game processing (step S22). In the bonus game processing, symbols are rearranged based on the rearrangement pattern data selected in step S19, and an effect is made based on the effect pattern data stored in step S21 over the T times of free games. The bonus game processing is detailed later using FIG. 13.

When determining in step S16 that the bonus game trigger has not been established, the main CPU 41 determines whether or not a prize has been established (step S23). When determining that a prize has been established, the main CPU 41 pays out coins in accordance with the number of inserted game media and the prizes (step S24).

In the case of reserving coins, the main CPU 41 performs processing of addition of the number of credits stored in the RAM 43. On the other hand, in the case of paying out coins, the main CPU 41 transmits a control signal to a hopper 66 (see FIG. 7) to pay out a prescribed number of coins.

When executing the processing of step S22 or S24, or determining that any prize has not been established in step S23 (determining that the game is lost), the main CPU 41 completes the present subroutine.

It is to be noted that the game played during execution of the processing of steps S11 to 16, 23 and 24 corresponds to the normal game in the present invention.

Next, the configuration of the slot machine 10 according to the present embodiment is described.

FIG. 2 is a perspective view showing appearance of the slot machine according to the present embodiment.

In the slot machine 10, as game media, coins, bills, or electronic valuable information corresponding to those may be used. However, in the present invention, the game media are not particularly limited, and examples thereof may include medals, tokens, electronic money, and tickets. It is to be noted that the above ticket is not particularly limited, and examples thereof may include a ticket with a barcode as described later.

The slot machine 10 includes a cabinet 11, a top box 12 installed on the upper side of the cabinet 11, and a main door 13 provided at the front of the cabinet 11.

The main door 13 is provided with a lower-side image display panel 16 as the display. The lower-side image display panel 16 is provided with a transparent liquid crystal panel, and displays a variety of information on a game, effect images and the like. The lower-side image display panel 16 in the slot machine 10 is configured by a transparent crystal liquid panel, and displays fifteen display blocks 28 of five columns and three rows. One symbol is displayed to each of the display blocks 28. Namely, three symbols are displayed on each symbol column. Further, on the lower-side image display panel 16, one winning line L is formed horizontally across the five display blocks 28 displayed on the central row. The winning line L defines a combination of symbols. When a combination of symbols rearranged on the winning line L is a prescribed combination, a payout is offered in accordance with the combination and the number of inserted game media (number of BETs).

Further, a number-of-credits display portion 31 and a number-of-payouts display portion 32 are set on the lower-side image display panel 16. In the number-of-credits display portion 31, the number of credits at the moment is displayed by an image. In the number-of-payouts display portion 32, the number of coins to be paid out is displayed by an image.

Moreover, although not shown, a touch panel 69 is provided at the front of the lower-side image display panel 16. The player can operate the touch panel 69 to input a variety of commands.

At a lower part of the lower-side image display panel 16, there are provided a control panel 20 including a plurality of buttons 23 to 27 with which the player input commands in accordance of the game progress, a coin receiving slot 21 from which coins are accepted into the cabinet 11, and a bill validator 22.

The control panel 20 is provided with the spin button 23, a change button 24, a CASHOUT button 25, the 1-BET button 26, and the maximum BET button 27. The spin button 23 is used for inputting a command to start scroll of symbols. The change button 24 is used in making a request for money exchange to an attendant of gaming facilities. The CASHOUT button 25 is used for inputting a command to pay out credited coins to the coin tray 18.

The 1-BET button 26 is used for inputting a command to bet one coin in a game out of credited coins. The maximum BET button 27 is used for inputting a command to bet the maximum number of coins bettable in one game (50 coins in the present embodiment).

The bill validator 22 discriminates whether a bill is true or not, and also accepts a true bill into the cabinet 11. It is to be noted that the bill validator 22 may be configured to read a ticket 39 with a barcode described below. Buried glass 34 on which a character of the slot machine 10 or the like is drawn is provided on the lower front of the main door 13, namely under the control panel 20.

The upper-side image display panel 33 is provided at the front of the top box 12. The upper-side image display panel 33 is provided with a liquid crystal panel to which, for example, an image representing introduction of contents of a game and explanation of a rule of the game.

Further, the top box 12 is provided with a speaker 29. At a lower side of the upper image display panel 33, there are provided a ticket printer 35, a card reader 36, a data display 37, and a key pad 38. The ticket printer 35 prints a barcode on a ticket as coded data of the number of credits, a date, an identification number of the slot machine 10, etc., and outputs the ticket as the ticket 39 with a barcode. The player can make another slot machine read the ticket 39 with a barcode to play a game on the slot machine, or exchange the ticket 39 with a barcode with a bill or the like at a prescribed place (e.g. cashier in a casino) of the gaming facilities.

The card reader 36 reads data from a smart card and writes data into the smart card. The smart card is a card owned by the player, and for example stores data for identifying the player and data on a history of games played by the player. The smart card may store data corresponding to coins, bills or credits. Further, a magnetic stripe card may be employed in place of the smart card. The data display 37 is configured by a fluorescent display and the like, and displays, for example, data read by the card reader 36 and data inputted by the player through the key pad 38. The key pad 38 is used for inputting a command and data on ticket issuance and the like.

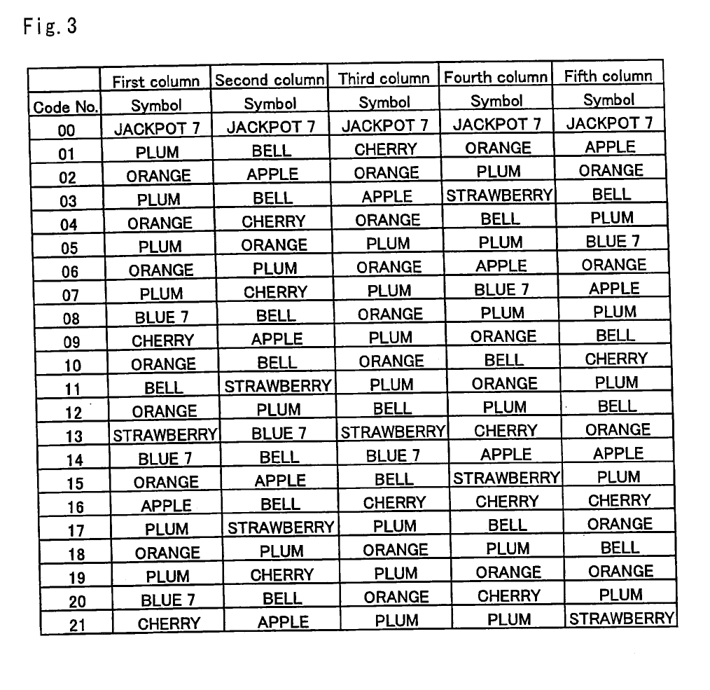

FIG. 3 is a pattern diagram showing columns of symbols to be displayed on each of the display blocks.

As described above, the fifteen display blocks 28 of five columns and three rows are displayed on the lower-side image display panel 16, and one symbol is displayed on each of the display blocks 28.

As shown in FIG. 3, on the five symbol columns of the display blocks 28, columns of a total 22 symbols consisting of code numbers “00” to “21” are scrolled. Each of the symbol columns is made up of a combination of symbols of “JACKPOT 7”, “BLUE 7”, “BELL”, “STRAWBERRY”, “PLUM”, “CHERRY”, “ORANGE”, and “APPLE”.

When five of symbols “JACKPOT 7”, “BLUE 7”, “BELL”, “STRAWBERRY”, “PLUM”, “CHERRY”, and “ORANGE” are rearranged on the winning line L, a previously set payout is offered (see FIG. 12).

The symbol of “APPLE” is a bonus game trigger (symbol for shifting to a bonus game). When five “APPLE” symbols are rearranged on the winning line L, the game can be shifted to the bonus game. In the present embodiment, the bonus game consists of free games (game where a player can play a prescribed number of games without betting game media).

When the spin button 23 is pressed down after the 1-BET button 26 or the maximum BET button 27 is pressed, symbols displayed on the display blocks 28 are scroll-displayed downward. After the lapse of prescribed time, symbols are rearranged. Further, a variety of prizes are previously set based on the combinations of symbols (see FIG. 12), and when a combination of symbols corresponding to a prize stop on the winning line L, a payout in accordance with the prize is added to the credits owned by the player. Further, when the bonus game trigger is established, the bonus game is generated.

It should be noted that, although the case was described in the present embodiment where symbols displayed on the display blocks 28 are automatically rearranged after the lapse of prescribed time from the screen-display of the symbols. However, in the present invention, a condition for stopping symbols is not particularly limited. For example, the slot machine 10 may be provided with a stop button, and symbols may be rearranged when the stop button is pressed down.

Further, although the case where a prize is determined based on a combination of symbols rearranged on the winning line L is described in the present embodiment, a prize may be decided based on the kind or the number of symbols rearranged on the display in the present invention.

Next, the effect pattern data are described.

FIG. 4 is a table showing the corresponding relations among a total payout amount, number of free games and effect pattern data in a bonus game.

As shown in FIG. 4, a plurality of kinds of effect pattern data are corresponded to the total payout amounts (0 to 100) and the numbers of free games (2 to 25) in the bonus game. For example, as effect pattern data that correspond to the case of the total payout amount being ten coins and the number of free games being three, different kinds of data, 10-3-a, 10-3-b, . . . , are prepared.

When the bonus game trigger is established and the number of free games and the total payout amount are determined in the gaming execution processing, one effect pattern data is selected out of a plurality of kinds of effect pattern data (10-3-a, 10-3-b, etc.) corresponding to the determined number of free games and the determined total payout amount.

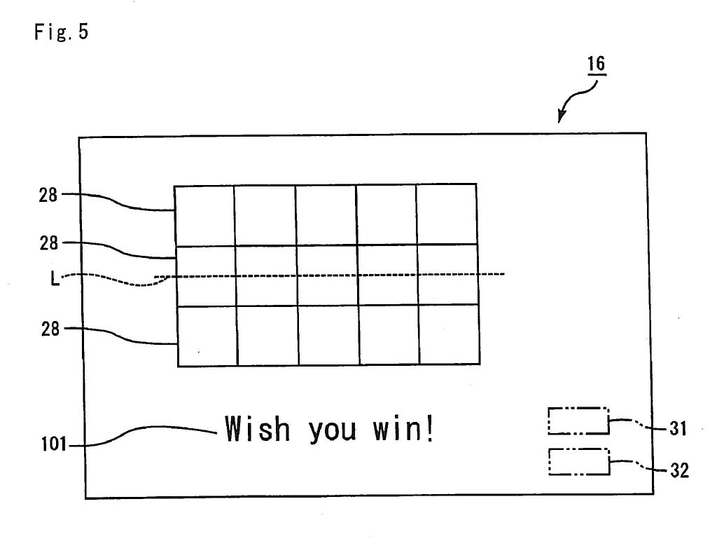

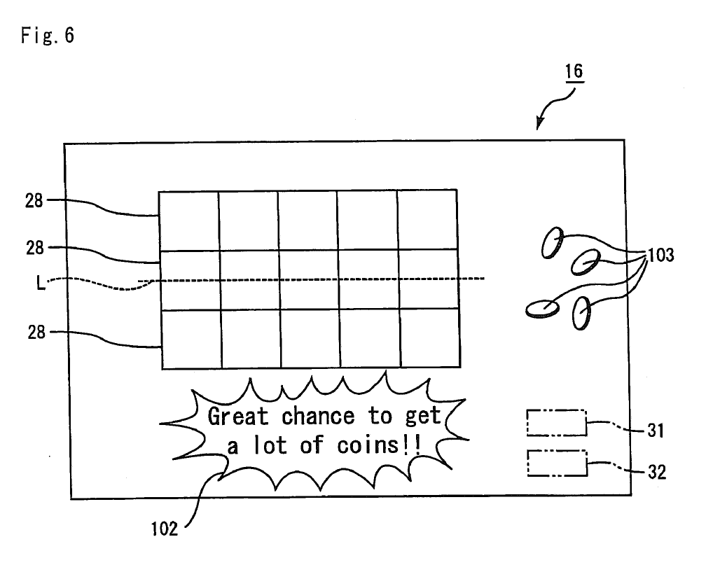

Next, images displayed on the lower-side image display panel 16 in the slot machine 10 are described. FIGS. 5 and 6 are views each showing an example of images displayed on the lower-side image display panel during a bonus game in which the total payout amount has been determined to be a relatively large value.

FIG. 5 shows an example of images displayed in early turns of a plurality of free games in the bonus game. An image 101 prompting expectation of the player is displayed on the lower side of the lower-side image display panel 16.

As the game turns go on, an image as shown in FIG. 6 is displayed.

As shown in FIG. 6, an image 102 suggesting a high possibility of the player acquiring a large payout is displayed on the lower side of the lower-side image display panel 16, and an image 103 showing coins as the payout are displayed on the right side of the lower-side image display panel 16.

As thus described, in the present embodiment, in accordance with the total payout amount of the bonus game, effects to raise the expectation of the player are gradually executed as the free games proceed.

FIG. 7 is a block diagram showing an internal configuration of the gaming machine shown in FIG. 2.

A gaming board 50 is provided with a CPU (central processing unit) 51, a ROM 55, a boot ROM 52, a card slot 53S corresponding to a memory card 53, and an IC socket 54S corresponding to a GAL (generic array logic) 54, which are mutually connected through an internal bus.

The memory card 53 is configured by a nonvolatile memory such as CompactFlash (registered trade mark), and stores a game program. The game program includes a symbol determination program. The symbol determination program is a program for determining symbols (code No. corresponding to symbols) to be rearranged on the display blocks 28.

Further, the card slot 53S is configured so as to be capable of inserting and pulling out the memory card 53, and connected to the motherboard 40 through an IDE bus. Therefore, the kind and contents of a game played on the slot machine 10 can be changed by pulling out the memory card 53 from the card slot 53S, writing another game program into the memory card 53, and inserting the memory card 53 into the card slot 53S. The game program includes a program relating to game progress. Further, the game program includes image data and sound data to be outputted during the game.

The CPU 51, the ROM 55 and the boot ROM 52 which are mutually connected through the internal bus are connected to the motherboard 40 through a PCI bus. The PCI bus transmits a signal between the motherboard 40 and the gaming board 50, and supplies power from the motherboard 40 to the gaming board 50.

The motherboard 40 is configured using a commercially available general-purpose motherboard (print wiring board mounted with fundamental components of a personal computer), and includes a main CPU 41, a ROM (read only memory) 42, and a RAM (random access memory) 43. The motherboard 40 corresponds to the controller in the present invention.

The ROM 42 is configured by a memory device such as a flash memory, and stores a program such as a BIOS (basic input/output system) to be executed by the main CPU 41 and permanent data. When the BIOS is executed by the main CPU 41, processing of initializing prescribed peripheral devices is performed concurrently with start of processing of downloading the game program stored in the memory card 53 through the gaming board 50. It should be noted that in the present invention, contents of the ROM 42 may be rewritable or not rewritable.

The RAM 43 stores data and a program to be used in actuation of the main CPU 41. Further, the RAM 43 is capable of storing a game program.

Further, the RAM 43 stores the number of credits, rearrangement pattern data, effect pattern data, and the like. The RAM 43 corresponds to the memory in the present invention.

Moreover, the motherboard 40 is connected with a later-described main body PCB (printed circuit board) 60 and a door PCB 80 through respective USBs. Further, the motherboard 40 is connected with a power source unit 45.

The main body PCB 60 and the door PCB 80 are connected with an instrument and a device that generate an input signal to be inputted into the main CPU 41 and with an instrument and a device, operations of which are controlled by a control signal outputted from the main CPU 41. The main CPU 41 executes the game program stored in the RAM 43 based on the input signal inputted into the main CPU 41 to perform prescribed computational processing and store the result into the RAM 43, or to transmit a control signal to each instrument and device as processing of controlling each instrument and device.

The main body PCB 60 is connected with a lamp 30, the hopper 66, a coin detecting portion 67, a graphic board 68, the speaker 29, the touch panel 69, the bill validator 22, the ticket printer 35, the card reader 36, a key switch 38S and the data display 37. The lamp 30 is lit up in a prescribed pattern based on the control signal outputted from the main CPU 41.

The hopper 66 is installed inside the cabinet 11, and pays out a prescribed number of coins from the coin payout exit 19 to the coin tray 18 based on the control signal outputted from the main CPU 41. The coin detecting portion 67 is provided inside the coin payout exit 19, and outputs an input signal to the main CPU 41 in the case of detecting payout of the prescribed number of coins from the coin payout exit 19.

The graphic board 68 controls display of images on the upper-side image display panel 33 and the lower-side image display panel 16 based on the control signal outputted from the main CPU 41. On each of the display blocks 28 of the lower-side image display panel 16, a background color decided by selection of a random number and a symbol scrolled or stopped is displayed. The number of credits stored in the RAM 43 is displayed to the number-of-credits display portion 31 of the lower-side image display panel 16. Further, the number of paid-out coins is displayed in the number-of-payouts display portion 31 of the lower-side image display panel 16.

The graphic board 68 includes a VDP (video display processor) for generating image data based on the control signal outputted from the main CPU 41, a video RAM for temporarily storing image data generated by the VDP, and the like. It is to be noted that the image data used in generation of image data by the VDP is included in the game program read from the memory card 53 and stored into the RAM 43.

The bill validator 22 discriminates whether a bill is true or not, and accepts a true bill into the cabinet 11. Upon acceptance of the true bill, the bill validator 22 outputs an input signal to the main CPU 41 based on an amount of the bill. The main CPU 41 stores the number of credits in accordance with the bill amount transmitted by the input signal into the RAM 43. The ticket printer 35 prints on a ticket a barcode formed by encoding data such as the number of credits stored in the RAM 43, a date, and an identification number of the slot machine 10 based on the control signal outputted from the main CPU 41, and outputs the ticket as the ticket 39 with a barcode.

The card reader 36 reads data from the smart card and transmits the read data to the main CPU 41, or writes data into the smart card based on the control signal from the main CPU 41. The key switch 38S is provided on the key pad 38, and when the key pad 38 is operated by the player, a prescribed input signal is outputted to the main CPU 41. The data display 37 displays data read by the card reader 36 and data inputted by the player through the key pad 38, in accordance with the control signal outputted from the main CPU 41.

The door PCB 80 is connected with a control panel 20, a reverter 21S, a coin counter 21C, and a cold cathode tube 81. The control panel 20 is provided with a start switch 23S corresponding to the spin button 23, a change switch 24S corresponding to the change button 24, a CASHOUT switch 25S corresponding to the CASHOUT button 25, the 1-BET switch 26S corresponding to the 1-BET button 26, and the maximum BET switch 27S corresponding to the maximum BET button 27. The respective switches 23S to 27S output input signals to the main CPU 41 when the corresponding buttons 23 to 27 are operated by the player.

The coin counter 21C is provided inside the coin receiving slot 21, and discriminate whether coins inserted into the coin receiving slot 21 by the player are true or not. Coins other than a true coin are discharged from the coin payout exit 19. Further, the coin counter 21C outputs an input signal to the main CPU 41 when a true coin is detected.

The reverter 21S operates based on the control signal outputted from the main CPU 41, and distributes a coin recognized by the coin counter 21C as the true coin into a cash box (not shown) installed inside the slot machine 10 or to the hopper 66. Namely, when the hopper 66 is filled with coins, the true coin is distributed to the cash box by the reverter 21S. On the other hand, when the hopper 66 is not filled with coins, the true coin is distributed to the hopper 66. The cold cathode tube 81 functions as a backlight installed on the rear face side of the lower-side image display panel 16 and the upper-side image display panel 33, and lit up based on the control signal outputted from the main CPU 41.

Next, processing performed on the slot machine 10 are described.

Since the game execution processing has already been described using FIG. 1, the description thereof is omitted here.

FIG. 8 is a flowchart showing a procedure for the activation processing.

This activation processing is processing performed by the motherboard 40 and the gaming board 50. It is to be noted that the memory card 53 is inserted in the card slot 53S in the gaming board 50, and the GAL 54 is installed in the IC socket 54S.

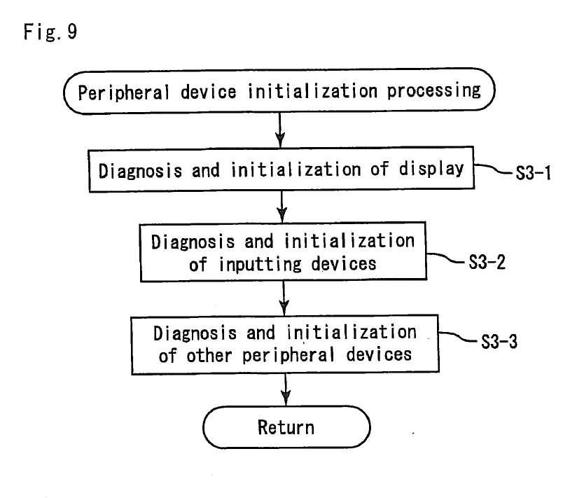

First, when the power switch is turned ON (power is turned ON) in the power source unit 45, the motherboard 40 and the gaming board 50 are activated (steps S1-1, S2-1). When the motherboard 40 and the gaming board 50 are activated, separate processing are respectively performed in parallel. Namely, in the gaming board 50, the CPU 51 reads an auxiliary authentication program stored in the boot ROM 52, and in accordance with the read auxiliary authentication program, the CPU 51 performs auxiliary authentication to check and verify that the authentication program was not previously falsified before being taken into the motherboard 40 (Step S2-2). Meanwhile, in the motherboard 40, the main CPU 41 executes the BIOS stored in the ROM 42, and develops compressed data incorporated in the BIOS to the RAM 43 (step S1-2). The CPU 41 then executes the BIOS developed to the RAM 43, and diagnoses and initializes a variety of peripheral devices (step S1-3). The processing of step S1-3 will be detailed later using FIG. 9.

Since the main CPU 41 is connected with the ROM 55 of the gaming board 50 through the PCI bus, the main CPU 41 reads the authentication program stored in the ROM 55, and also performs processing of storing the read authentication program into the RAM 43 (step S1-4). At this time, the main CPU 41 obtains a checksum by ADDSUM system (standard checking function) in accordance with the function of the standard BIOS of the BIOS, and makes the RAM 43 store the authentication program while performing processing of checking whether or not the storage is performed without an error.

Next, after checking what is connected with an IDE bus, the main CPU 41 makes access to the memory card 53 inserted in the card slot 53S through the IDE bus, and reads a game program and a game system program from the memory card 53. In this case, the main CPU 41 reads data constituting the game program and the game system program in every four bytes. Subsequently, the main CPU 41 performs authentication to check and verify that the read authentication program was not previously falsified in accordance with the authentication stored in the RAM 43 (step S1-5). When the authentication processing is normally completed, the main CPU 41 makes the RAM 43 write and store the game program and the game system program, which were the objects to be authenticated (which have been authenticated) (step S1-6). Next, the main CPU 41 makes access to the GAL 54 connected to the IC socket 54S through the PCI bus, reads data for payout rate setting from the GAL 54, and makes the RAM 43 write and store the data (step S1-7). The main CPU 41 then reads country identification information stored in the ROM 55 in the gaming board 50 through the PCI bus, and further makes the RAM 43 store the read country identification data (step S1-8).

After performing the foregoing processing, the main CPU 41 sequentially reads and executes the game program and the game system program to advance the game.

FIG. 9 is a flowchart showing a procedure for peripheral device initialization processing.

First, the main CPU 41 diagnoses and initializes the display (step S3-1). In this processing, the main CPU 41 transmits a request signal to the graphic board 68, and determines whether or not the main CPU 41 has received a prescribed response signal, while clearing a prescribed storage region, and the like.

Next, the main CPU 41 diagnoses and initializes a variety of input devices (step S3-2). In this processing, the main CPU 41 transmits a request signal to the input devices such as the start switch 23S, the change switch 24S, the CASHOUT switch 25S, the 1-BET switch 26S, the maximum BET switch 27S, and the touch panel 69, and determines whether or not the main CPU 41 has received a prescribed response signal.

Next, the main CPU 41 diagnoses and initializes the other peripheral devices connected to the main CPU 41 (step S3-3). Thereafter, the main CPU 41 completes the present subroutine.

In the present embodiment, the case of the slot machine 10 being a standalone type was described. However, in the present invention, a plurality of slot machines maybe connected to a central controller through a network so that the plurality of slot machines may be controlled by the central controller.

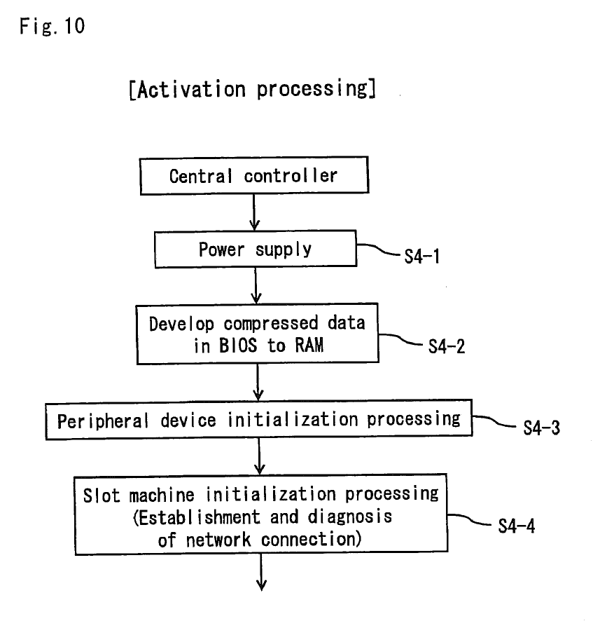

FIG. 10 is a flowchart showing a subroutine of activation processing executed by the central controller.

First, when a power switch is turned ON (power is turned ON) in a power source unit, a motherboard is activated (step S4-1).

In the motherboard, a CPU executes a BIOS stored in a ROM, and develops compressed data incorporated in the BIOS to a RAM (step S4-2). The CPU then executes the BIOS developed to the RAM, and diagnoses and initializes a variety of peripheral devices such as a display (step S4-3).

Next, the CPU executes initialization processing on each slot machine. In this processing, the CPU establishes network connection of the central controller with each slot machine, while diagnosing whether or not the network is functioning properly.

After performing the foregoing processing, the CPU reads and executes the game control program to control the progress of a game executed by the plurality of slot machines.

FIG. 11 is a flowchart showing a subroutine of the symbol determination processing that is called and executed in step S14 of the subroutine shown in FIG. 1. This processing is performed when the main CPU 41 executes the symbol determination program stored in the RAM 43.

First, the main CPU 41 executes a program for random number generation included in the symbol determination program to select a random number value corresponding to each of the symbol columns out of the range of numeric values of 0 to 255 (step S501). In the present embodiment, the case of generating random numbers on the program (the case of using so-called software random numbers) is described. However, in the present invention, a random number generator may be previously provided, and random numbers may be extracted from the random number generator (so-called hardware random numbers may be used).

Next, based on selected five random number values, the main CPU 41 decides code No. of each symbol column (see FIG. 3) (step S502). The code No. of each symbol column corresponds to the code No. of a symbol to be rearranged on the winning line L. The main CPU 41 determines a prize by determining the code No. of each symbol column. For example, when the main CPU 41 determines the code No. of the symbols to be “00”, “00”, “00”, “00”, and “00”, it means that the main CPU 41 determines the prize to be “JACKPOT 7”.

Here, prizes in the present embodiment are described.

FIG. 12 is a diagram showing the relation of a plurality of kinds of prizes, and establishment probabilities and the numbers of payouts for each of the prizes.

When five symbols of “APPLE” are rearranged on the winning line L and the bonus game trigger is won, the bonus game is generated.

Further, when five symbols of “JACKPOT 7” are rearranged on the winning line L, 30 coins are paid out. Similarly, when five symbols of “BLUE 7”, “BELL”, “STRAWBERRY”, “PLUM”, “CHERRY”, or “ORANGE” are rearranged on the winning line L, payouts are made in amounts corresponding to prizes for the respective combinations.

FIG. 13 is a flowchart showing a subroutine of the bonus game processing that is called and executed in step S22 of the subroutine shown in FIG. 1.

First, the main CPU 41 controls scroll of symbols in the display blocks 28 based on the rearrangement pattern data stored in the RAM 43 in step S19 of FIG. 1 (step S60). Specifically, the main CPU 41 scroll-displays and stops symbols in the display blocks 28 in each time of the free games in such a manner that the symbols are rearranged in a mode determined by the rearrangement pattern data stored in the RAM 43.

Subsequently, the main CPU 41 executes an effect based on the effect pattern data selected in step S21 of FIG. 1 (step S61). Specifically, based on the determined total payout amount, the main CPU 41 outputs images and sound, thereby executing effects to gradually enhance the expectation of the player as the turns of the free games go on (see FIGS. 5 and 6).

Next, the main CPU 41 determines whether or not the prize has been established (step S62). When determining that the prize has been established, the main CPU 41 pays out coins in accordance with the prize (step S63).

When determining in step S62 that any prize has not been established (determining that the game is a loss) or executing the processing of step S63, the main CPU 41 executes processing of subtracting 1 from the value of the number T of free games (step S64).

Next, the main CPU 41 determines whether or not the number T of free games is 0 (step S65). Namely, the main CPU 41 determines whether or not the free games have been played for the number of times determined in step S17 of FIG. 1.

When determining that the value T is not 0, the main CPU 41 returns the processing to step S60. When determining that the value T is 0, the main CPU 41 completes the present subroutine.

As thus described, the slot machine 10 according to the present embodiment has the lower-side image display panel 16 (display) capable of rearranging symbols. Further, the slot machine 10 includes the RAM 43 (memory) that stores a plurality of kinds of the effect pattern data for use in executing an effect, each of the effect pattern data being corresponded to a total payout amount in the bonus game consisting of a plurality of free games in which the symbols are rearranged to the lower-side image display panel 16. Moreover, the gaming machine includes the motherboard 40 (controller) programmed to execute the following processing (a) to (f), namely, (a) executing a normal game in which the symbols are rearranged and displayed to the lower-side image display panel 16, (b) deciding whether or not to execute the bonus game, (c) determining a rearrangement pattern showing the symbols to be rearranged in each of the free games constituting the bonus game, or a combination of those symbols, (d) determining a total payout amount in the bonus game by calculating a payout amount in each of the free games based on the rearrangement pattern determined in the processing (c) and summing the payout amount in all of the free games, (e) selecting one effect pattern data out of effect pattern data corresponded to the total payout amount determined in the processing (d) among the plurality of kinds of the effect pattern data stored in the RAM 43, and (f) executing rearrangement of the symbols displayed to the lower-side display panel 16 based on the rearrangement pattern determined in the processing (c), while executing an effect based on the effect pattern data selected in the processing (e), in each of the free games constituting the bonus game when it is decided in the processing (b) that the bonus game will be executed.

Namely, on the above slot machine 10, the bonus game is played after a total payout amount in the bonus game has been determined, and further, an effect is executed based on effect pattern data corresponding to the determined total payout amount. Therefore, when the total payout amount is determined to be a relatively large value, an effect suggesting a large amount of payout can be executed, whereas when the total payout amount is determined to be a relatively small value, an effect that excessively provokes an expectation of the player can be avoided. Accordingly, since an effect in accordance with the total payout amount to be offered can be executed, a condition where a payout expected from the effect is significantly different from an actual total payout amount can be avoided so that the player can be prevented from becoming mistrustful.

Moreover, by determining the total payout amount prior to execution of the bonus game, an effect in accordance with the total payout amount can be executed as a series of effects over a plurality of unit games, it is possible to gradually raise the expectation of the player for results of the bonus game as each of the unit games is played. It is thus possible to further increase amusement of the bonus game.

Furthermore, since the rearrangement pattern of the symbols in the bonus game is determined by first determining symbols to be rearranged in each of the free games constituting the bonus game or a combination of the symbols by means of random numbers or the like before the bonus game is executed, it is not necessary to previously store the rearrangement pattern data, and thus it is possible to reduce the capacity of the memory to be used.

In the present embodiment, the case was described where effect pattern data are corresponded to a total payout amount in the bonus game and the number of free games constituting the bonus game. However, in the present invention, the number of unit games constituting the bonus game may be fixed, and the effect pattern data may be corresponded only to the total payout amount of the bonus game.

Further, in the case of determining the total payout amount in the bonus game after the bonus game has been decided to be executed in the normal game as in the present embodiment, the total payout amount in the bonus game may be determined based on a result of the normal game executed until the bonus game has been decided to be executed. For example, when a large number of the normal games have been played before the bonus game is decided to be executed, the rearrangement pattern of the symbols in each of the unit games may be determined such that the total payout amount in the bonus game becomes a relatively large value.

Moreover, in the present embodiment, the case was described where the rearrangement pattern of the symbols in each of the unit games constituting the bonus game is determined (the total payout amount in the bonus game is determined) after the bonus game has been decided to be executed in the normal game. However, in the present invention, the timing for determining rearrangement pattern of the symbols in each of the unit games constituting the bonus game (the timing for determining the total payout amount in the bonus game) is not particularly limited so long as the timing is before the execution of the bonus game. For example, the timing may be determined when game media are betted in the normal game.

Furthermore, although the case was described in the present embodiment where the slot machine 10 is a video slot machine, the gaming machine in the present invention may be a mechanical slot machine provided with reels.

Although the present invention has been described with reference to embodiments thereof, these embodiments merely illustrate specific examples, not restricting the present invention. The specific structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art will easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there has been described processing to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processes described in the present specification are to be executed by various types of devices, in principle. Further, other structures required for conducting each step will be apparent from the aforementioned description.

What is claimed as new and desired to be secured by Letters Patent of the United States is:

1. A gaming machine, comprising:
a display capable of arranging and displaying symbols;
a memory that stores a plurality of kinds of effect pattern data for use in executing an effect, each of said effect pattern data being corresponded to a total payout amount in a bonus game in which a unit game executing rearrangement and display of said symbols to said display is played over a plurality of times; and
a controller, said controller programmed to execute processing of
(a) executing a normal game in which said symbols are rearranged and displayed to said display,
(b) deciding whether or not to execute said bonus game,
(c) determining a rearrangement pattern showing said symbols to be rearranged in each of said unit games constituting said bonus game, or a combination of said symbols,
(d) determining a total payout amount in said bonus game by calculating a payout amount in each of said unit games based on the rearrangement pattern determined in said processing (c) and summing the payout amount in all of said unit games,
(e) selecting one effect pattern data out of effect pattern data corresponded to the total payout amount determined in said processing (d), among the plurality of kinds of said effect pattern data stored in said memory, and
(f) executing rearrangement of said symbols displayed to said display based on the rearrangement pattern determined in said processing (c), while executing an effect based on the effect pattern data selected in said processing (e) in each of said unit games constituting said bonus game when it is decided in said processing (b) that said bonus game will be executed.

2. The gaming machine according to claim 1,
wherein
said processing (c) is processing of determining said symbols to be rearranged in each of said unit games constituting said bonus game, or a combination of said symbols when it is decided in said processing (b) that said bonus game will be executed.

3. A gaming machine, comprising:
a display capable of arranging and displaying symbols;
a memory that stores a plurality of kinds of effect image data for use in executing an effect, each of said effect image data being corresponded to a total payout amount in a bonus game in which a unit game executing rearrangement and display of said symbols to said display is played over a plurality of times; and
a controller, said controller programmed to execute processing of
(a) executing a normal game in which said symbols are rearranged and displayed to said display,
(b) deciding whether or not to execute said bonus game,
(c) determining a rearrangement pattern showing said symbols to be rearranged in each of said unit games constituting said bonus game, or a combination of said symbols,
(d) determining a total payout amount in said bonus game by calculating a payout amount in each of said unit games based on the rearrangement pattern determined in said processing (c) and summing the payout amount in all of said unit games,
(e) selecting one effect image data out of effect image data corresponded to the total payout amount determined in said processing (d), among the plurality of kinds of said effect image data stored in said memory, and
(f) executing rearrangement of said symbols displayed to said display based on the rearrangement pattern determined in said processing (c), while displaying to said display an effect image based on the effect image data selected in said processing (e) in each of said unit games constituting said bonus game when it is decided in said processing (b) that said bonus game will be executed.

4. The gaming machine according to claim 3,
wherein
said processing (c) is processing of determining said symbols to be rearranged in each of said unit games constituting said bonus game, or a combination of said symbols when it is decided in said processing (b) that said bonus game will be executed.

5. A method for controlling the gaming machine, comprising the steps of:
(a) executing a normal game in which symbols are rearranged and displayed to said display,
(b) deciding whether or not to execute a bonus game in which a unit game executing rearrangement and display of said symbols to said display is played over a plurality of times,
(c) determining a rearrangement pattern showing said symbols to be rearranged in each of said unit games constituting said bonus game, or a combination of said symbols,
(d) determining a total payout amount in said bonus game by calculating a payout amount in each of said unit games based on the rearrangement pattern determined in said step (c) and summing the payout amount in all of said unit games,
(e) selecting one effect pattern data out of effect pattern data corresponded to said total payout amount determined in said step (d) among the plurality of kinds of said effect pattern data for use in executing an effect stored in said memory, each of said effect pattern data being corresponded to the total payout amount in the bonus game, and
(f) executing rearrangement of said symbols displayed to said display based on the rearrangement pattern determined in said step (c), while executing an effect based on the effect pattern data selected in said step (e), in each of said unit games constituting said bonus game when it is decided in said step (b) that the bonus game will be executed.

6. The method for controlling the gaming machine according to claim 5, wherein
said step (c) is step of determining said symbols to be rearranged in each of said unit games constituting said bonus game, or a combination of said symbols when it is decided in said step (b) that said bonus game will be executed.
